(19) United States
(12) Patent Application Publication
(10) Pub. No.: US 2008/0204247 A1
(43) Pub. Date: Aug. 28, 2008

(54) Integrated Eas/Rfid Device and Disabling Devices Therefor

(75) Inventors: Ming-Ren Lian, Boca Raton, FL (US); Gary Mark Shafer, Charlotte, NC (US)

Correspondence Address: IP LEGAL DEPARTMENT;TYCO FIRE & SECURITY SERVICES, ONE TOWN CENTER ROAD, BOCA RATON, FL, 33486, US

(73) Assignee: SENSORMATIC ELECTRONICS CORPORATION, Boca Raton, FL (US)

(21) Appl. No.: 11/791,089

(22) PCT Filed: Nov. 18, 2005
(86) PCT No.: PCT/US05/41679

§ 371 Date: Apr. 28, 2008

Related U.S. Application Data
(60) Provisional application No. 60/630,351, filed on Nov. 23, 2004.

(51) Int. Cl. G08B 13/14

(52) U.S. Cl. 340/572.3

(57) ABSTRACT

An integrated electronic article surveillance (EAS) and radiofrequency identification (RFID) marker is provided which a semiconductor device which may he coupled to an antenna for receiving and retransmitting energy and signals to the antenna. A current receiving front end section of the semiconductor device communicates with at least one other section of the device so more than one function can be implemented upon receiving and retransmitting energy and signals. A first switch is operatively coupled to the front end section such that the functions are entirely but reversibly disabled upon closure of the first switch thereby effecting a reversible EAS function. A second switch is operatively coupled to the front end section such that at least one of the functions is at least partially disabled upon closure of the second switch. RFID functions of the marker am retained upon EAS deactivation.

### CROSS-REFERENCE TO RELATED APPLICATIONS

This application claims the benefit of priority under 35 U.S.C. §119 of U.S. Provisional Patent Application Ser. No. 60/630,3 51 filed on Nov. 23, 2004 entitled “Disabling Devices for an Integrated EAS/RFID Device”, the entire contents of which is incorporated by reference herein.

### BACKGROUND OF THE INVENTION

1. Technical Field

This invention relates to an integrated electronic article surveillance (EAS) and radiofrequency identification (RFID) device which is capable of performing dual EAS/RFID functions and particularly to a device which is capable of being reactivated to resume performance of both EAS and RFID functions.

2. Background of Related Art

In general, it is known that many devices which are designed to perform only an EAS function (i.e., marking an article as “activated” or “deactivated”) are capable of being reactivated. For example, magnetic processes for deactivating an EAS marker provide a simple process for deactivation through magnetization or demagnetization of a magnetic bias strip. Reactivation is possible in this type of device since the magnetization process is reversible. However, in the case of EAS markers which are deactivated by means of a radiofrequency wave typically at a range of about 8.2 MHz (±10%), such as an RF LC (radiofrequency inductor capacitor) resonant marker, an induced high voltage can break down the dielectric layer at a weak spot, creating a short circuit. This is a destructive process and, typically, reactivation is not possible.

With the advent of RFID technology, many retailers are considering tagging merchandise (e.g., per item, per case, per pallet) with RFID tags. At the same time, electronic article surveillance (EAS) technology and devices have proven critical to the reduction of theft and so called “shrinkage”. It is envisioned that RFID devices can also provide many of the same advantages known to EAS technology coupled with additional advantages or capabilities such as inventory control, shelf reading, non-line of sight reading, etc. However, there are several issues pertaining to previously known combination EAS and RFID devices or tags or labels. Such issues include the following:

Cost—Combined EAS/RFID tags or labels are generally more expensive for a retailer/manufacturer since two devices and two separate readers or deactivators are typically required.

Size—The size of a combined configuration is generally larger.

Interference—Interference can occur, if the devices are overlapped resulting in degrading performance of either or both EAS and RFID functions, unless specific design features are provided to reduce the interference caused by the overlapping.

Such issues relating to cost, size and performance degradation and interference caused by overlapping are addressed and overcome in commonly owned, U.S. Provisional Patent Application No. 60/628,303 filed on Nov. 15, 2004 entitled “COMBO EAS/RFID LABEL OR TAG”, now co-pending PCT Application Ser. No. [Attorney Docket No. F-TP-00023US/WO], filed on Nov. 15, 2005, entitled “COMBINATION EAS AND RFID LABEL OR TAG”, the entire contents of both of which are incorporated by reference herein. However, with respect to integrated EAS/RFID markers, there is no known solution to the problem of reactivating the EAS function of the EAS/RFID marker after deactivation. It would therefore be desirable to design an integrated EAS/RFID marker which is economical and solves many of the issues discussed above.

### SUMMARY OF THE INVENTION

It is an object of the present invention to provide an integrated EAS/RFID device which retains its state even in the absence of power.

More particularly, the present disclosure relates to a semiconductor for use with an electronic article surveillance (EAS) and radio frequency identification (RFID) marker. The semiconductor includes a current receiving portion which couples to an antenna and is configured to communicate with at least one other portion of the semiconductor such that a multiplicity of functions can be performed by the at least one other portion of the semiconductor upon receiving and retransmitting energy and signals from the antenna. The semiconductor also includes at least one of a first switch operatively coupled to the current receiving portion such that the multiplicity of functions are disabled upon closure of the first switch and a second switch operatively coupled to the current receiving portion such that at least one of the multiplicity of functions is at least partially disabled upon closure of the second switch. At least one of the first switch and the second switch includes a preset memory, and the preset memory sets a conduction state of at least one of the first switch and the second switch. The conduction state can be set during active operation of the semiconductor and can be maintained when the device is in a power down state by a power controller having memory storage for storing the conduction state. The power controller may modulate at least one of the first switch and the second switch.

The current receiving portion may be a current rectifying front end portion which includes a source electrode; a drain electrode; a modulation impedance and a first diode both of which being operatively coupled to the source electrode and to the drain electrode to form a parallel resonant inductive capacitive (LC) circuit; and a second diode operatively coupled to the drain electrode such that the LC circuit forms a current rectifying circuit. The semiconductor may include an antenna electromagnetically coupled to the semiconductor and designed to receive and retransmit the energy and signal from and to the current receiving portion.

The present disclosure relates also to an integrated electronic article surveillance (EAS) and radiofrequency identification (RFID) marker which includes an antenna; a semiconductor adapted to couple to the antenna, and being configured to receive and transmit energy and signals to the antenna, the semiconductor including: a current receiving end portion disposed in the semiconductor and configured to communicate with at least one other portion of the semiconductor such that a multiplicity of functions can be performed by the at least one other portion upon receiving and retransmitting the energy and signals from and to the antenna. The semiconductor includes at least one of a first switch operatively coupled to the current receiving portion such that the multiplicity of functions are disabled upon closure of the first switch; and a second switch operatively coupled to the current receiving portion such that at least one of the multiplicity of functions is at least partially disabled upon closure of the second switch.

### BRIEF DESCRIPTION OF THE DRAWINGS

The subject matter regarded as the embodiments is particularly pointed out and distinctly claimed in the concluding portion of the specification. The embodiments, however, both as to organization and method of operation, together with objects, features, and advantages thereof, may best be understood by reference to the following detailed description when read with the accompanying drawings in which:

FIG. 1 is a schematic diagram of an integrated EAS/RFID device according to the present disclosure;

FIG. 2A is a circuit schematic diagram of one embodiment of the integrated EAS/RFID device of FIG. 1 for high frequency operation;

FIG. 2B is a circuit schematic diagram of one embodiment of the integrated EAS/RFID device of FIG. 1 for radio frequency operation; and

FIG. 3 is a schematic diagram of a floating/buried gate device for controlling channel resistance.

### DETAILED DESCRIPTION

An integrated EAS/RFID device typically does not provide complete functionality without an appropriate method of deactivation especially with respect to the EAS function of the device. (An EAS marker or label is commonly referred to as a single bit transponder because it contains only one piece of information: whether the label is activated or de-activated.) The integrated EAS/RFID device of the present disclosure is capable of performing dual EAS/RFID functions, i.e., the RFID function provides extensive information about the tagged item while the attached EAS function provides limited information regarding the item (activated/de-activated).

In general, the detection range of the EAS function is greater than the detection range of the RFID function. One attractive feature of such an integrated device is that it is possible to provide an EAS deactivation function based on complicated code preset in the RFID device. Once confirmed, the RFID portion of the integrated device creates an electric pulse to change the condition of the integrated device, rendering the EAS and/or RFID device function inactive. The present disclosure describes a device which is capable of changing or retaining its impedance state even in the absence of power.

Moreover, the novel approach of deactivation of the EAS portion or EAS/RFID portion described herein permits the retention of any data stored in the RFID portion of the integrated EAS/RFID device. With this approach, significant savings are achieved by using one label to accomplish dual functions. The RFID functions are used for the logistical operations, such as manufacturing process control, merchandise transport, inventory, item verification for check out, return, etc. The EAS function is performed for antitheft purposes at the exit point.

Basically, at least one switch with a preset memory enabling performance of a single bit EAS function is introduced into a portion of the RFID circuitry. The conduction state of the switches (e.g., on/off, low/high resistance) can be set during the active (power up) duration of the device, and maintained when the device is in the power down state.

Numerous specific details may be set forth herein to provide a thorough understanding of the embodiments of the invention. It will be understood by those skilled in the art, however, that various embodiments of the invention may be practiced without these specific details. In other instances, well-known methods, procedures, components and circuits have not been described in detail so as not to obscure the various embodiments of the invention. It can be appreciated that the specific structural and functional details disclosed herein are representative and do not necessarily limit the scope of the invention.

It is worthy to note that any reference in the specification to “one embodiment” or “an embodiment” according to the present disclosure means that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

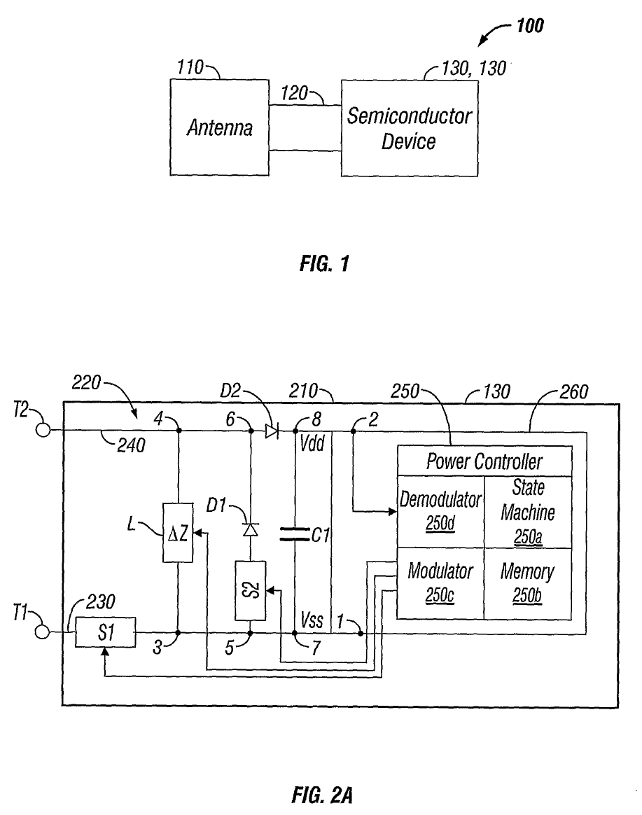

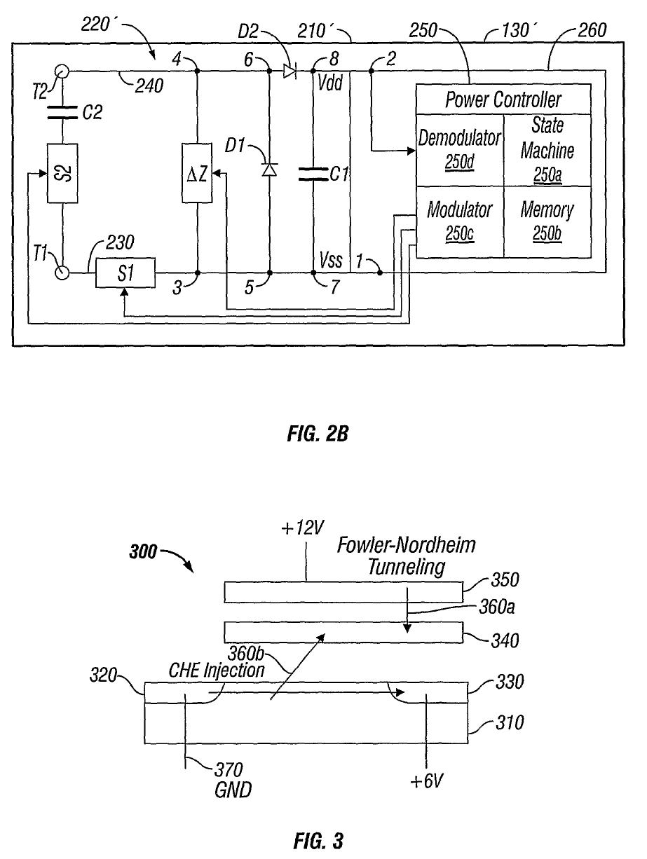

Referring now in detail to the drawings wherein like parts may be designated by like reference numerals throughout, as illustrated in FIG. 1, the components of a passive integrated EAS/RFID tag or marker 100 of the present disclosure include an antenna 110 which is an energy coupling device designed to receive and retransmit the energy and signal 120 from an intelligent semiconductor device 130. The antenna 110 may be dedicated to receiving and transmitting energy and signals related to the tag or marker 100. The antenna 110 may be a dipole antenna for ultrahigh frequency (UHF) applications and may be a coil antenna for radio frequency (RF) applications. The embodiments are not limited in this context. Semiconductor 130 is designed to perform analytical and computational functions as explained in more detail below with respect to FIG. 2. Antenna 110 is operatively coupled to the semiconductor device 130 via signal 120 and serves as a transceiver device for both EAS and RFID functions. Although the antenna 110 is shown as being separate from the semiconductor device 130, in one embodiment, the antenna 110 may also be formed on the semiconductor device 130 as an integrated unit. The embodiments are not limited in this context.

The semiconductor device 130 includes built-in, dual-function circuits, for controlling EAS and RFID functions, respectively. It is possible that the circuitry controlling the EAS/RFID functions may share the same (or portions of the same) circuitry or be coupled to a common component, e.g., antenna 110. As discussed later, in one particular embodiment, a diode commonly used for rectification (usually non-linear) can be designed to implement certain EAS functions such as mixing and harmonic generation. A reader may also be designed to cooperate with either (or both) the EAS or RFID devices/functions. Such a reader is disclosed in commonly-owned, U.S. Provisional Patent Application No. 60/629,571, filed on Nov. 18, 2004, entitled “INTEGRATED 13.56 MHz EAS/RFID DEVICE”, now concurrently filed PCT Patent Application No. [Attorney Docket No. F-TP-00018US/WO], entitled “EAS READER DETECTING EAS FUNCTION FROM RFID DEVICE”, both of which are incorporated herein by reference in their entirety.

The semiconductor device 130 must be fully powered in order to execute the required logic operations for various RFID applications, such as access control, document tracking, livestock tracking, product authentication, retail tasks, and supply chain tasks. The main function of an EAS device is to create a unique signature in response to a system inquiry (preferably accomplished without fully activating the RFID logic functions of an RFID tag or marker in the vicinity). As a result, the effective EAS read range is greater than the effective RFID read range and EAS devices/functions tend to be more resilient to shielding and detuning effects.

As can be appreciated, it is important to deactivate or disable the EAS/RFID devices once the item is purchased or the device leaves the premises for reasons relating to privacy and/or interference with other EAS/RFID operated facilities located in stores. Moreover, there are occasions when customers who have purchased an item having an RFID label prefer their personal information to remain confidential. For this purpose, the RFID device is well-suited to set different levels of security, by setting up a standard protocol, i.e., the deactivation of the EAS function can be achieved through the intelligence of the RFID device.

FIG. 2A illustrates a specific example of the integrated EAS/RFID semiconductor device 130 according to the present disclosure having EAS function deactivation capability at a UHF band range suitable for RFID applications. The semiconductor device 130 is mounted on a substrate 210. The semiconductor device 130 includes a current receiving front end portion 220, which can also serve as a current rectifying front-end portion of the EAS/RFID semiconductor device 130. The front end portion 220 is commonly coupled at junctions 1 and 2 to another or a back end portion 260 of the EAS/RFID semiconductor device 130 which performs a multiplicity of RFID functions. The front-end portion 220 is coupled to the antenna 110 at terminals T1 and T2. Terminal T1 couples the antenna 110 to source electrode 230 while terminal T2 couples antenna 110 to drain electrode 240. A variable or modulation impedance ΔZ, is coupled in parallel to electrodes 230 and 240 at junctions 3 and 4, respectively. A diode D1 is coupled in parallel to electrodes 230 and 240 at junctions 5 and 6, respectively. Similarly, a capacitor C1 is coupled in parallel to electrodes 230 and 240 at junctions 7 and 8, respectively. Source voltage Vss at junction 7 and drain voltage Vdd at junction 8 provide energy for storage by the capacitor C1.

In one embodiment, the EAS portion 220 of the device mixes an UHF (ultrahigh frequency) signal with a radio frequency (RF) electric field based on the non-linearity of the front end 220 of the integrated EAS/RFID device 130. More particularly, such an embodiment is described in detail in commonly owned, co-pending U.S. patent application Ser. No. 11/144,883 filed on Jun. 3,2005 entitled “TECHNIQUES FOR DETECTING RFID TAGS IN ELECTRONIC ARTICLE SURVEILLANCE SYSTEMS USING FREQUENCY MIXING,” the contents of which is incorporated by reference herein in its entirety.

For deactivation of the EAS function, at least one of the switches S1 and S2 is inserted into the front end portion 220. Specifically, switch S1 is disposed in the source electrode 230 between terminal T1 and junction 3, and is coupled to terminal T1 and to junction 3. Therefore, switch S1 controls current flow to the entire semiconductor device 130 since switch S1 is disposed on the source electrode 230 upstream of modulation impedance ΔZ, diode D1 and capacitor C. In one embodiment, switch S2 is disposed between junction 5 on the source electrode 230 and diode D1 and is coupled to source electrode 230 and to diode D1. Therefore, switch S2 controls current flow through the diode D1.

Switches S1 and S2 are designed having certain fundamental characteristics, e.g., a preset memory and programmable elements. The conduction state (e.g., on/off, low/high resistance) of each switch S1 and S2 can be set during the active (power up) duration of the device, and maintained when the semiconductor device 130 is in the power down state. The programming functions are provided by the RFID back end portion 260 via a power controller 250 which includes at least a state machine 250a, which is a switching device which executes logic operations, memory 250b, modulator 250c and demodulator 250d. The modulator 250c is coupled to the modulation impedance ΔZ, switch S1 and switch S2. Drain electrode 240 is coupled at junction 2 to the demodulator 250d. The state machine 250a determines the operating condition of and controls switches S1 and S2 and the modulation impedance ΔZ. The operating conditions are stored in the memory 250b. The state machine 250a also controls switches S1 and S2 and modulation impedance ΔZ through modulator 250c. Energy is provided to the power controller 250 typically via the capacitor C1.

Once switch S2 in conjunction with switch S1 is turned “on”, the resistance is sufficiently decreased to maximize the sensitivity of the EAS/RFID marker 100. Once switch S1 or S2 is turned “off”, the resistance is raised significantly to de-sensitize the EAS function. In addition, semiconductor 130 is designed such that the RFID device functions differently depending on which switch is turned “off”. For example, when switch S1 is turned “off”, the RFID functions 260 of the semiconductor device 130 are disabled since switch S1 controls current flow to the source electrode 230 from terminal T1. In contrast, since switch S2 controls current flow only through the diode D1, only a reduction in RFID performance or function of the RFID functions 260 occurs if switch S2 is turned “off”. Memory 250b may comprise, for example, program memory, data memory, or any combination thereof. Memory 250b may also comprise, for example, random access memory (RAM), read only memory (ROM), programmable read only memory (PROM), erasable programmable read only memory (EPROM), electrically erasable programmable read only memory (EEPROM), or combinations thereof, and the like.

FIG. 2B illustrates a specific example of an integrated EAS/RFID semiconductor device according to the present disclosure having EAS function deactivation capability at a RF band range suitable for RFID applications. More particularly, semiconductor device 130′ is identical to semiconductor device 130 except that the semiconductor device 130′ is mounted on a substrate 210′ which also includes a current receiving front end portion 220′. The difference between front end portion 220′ and front end portion 220 of semiconductor device 130 is that switch S2 is no longer coupled in series with diode D1 between junctions 5 and 6. Rather, switch S2 is now coupled across terminals T1 and T2. Furthermore, a capacitor C2 is also coupled in series with switch S2 across terminals T1 and T2. The front end portion 220′ can also serve as a current rectifying front-end portion of the EAS/RFID semiconductor device 130′. The capacitor C2 enables tuning or frequency matching of the resonance frequency of the front end portion 220′ controlled by the modulation impedance ΔZ to the frequency of the interrogation signal 120 (See FIG. 1).

Typically a loss of power source to the integrated marker 100 normally occurs when the merchandise is carried from the deactivation station to the exit point where the EAS system is located. The effectiveness of the EAS function deactivation is directly proportional to the magnitude of the on/off resistance ratio RR of switches S1 and S2, as defined by the resistance of the switch in the OFF position, Roff, divided by the resistance of the switch in the ON position, Ron, or RR=_{off}/Rₒₙ.

One envisioned device which provides the switching function capability to serve as switches S1 and S2 is similar to a nonvolatile flash memory device (or floating gate device), as shown in FIG. 3. More particularly, FIG. 3 illustrates a schematic diagram of a floating/buried gate device 300 for controlling channel resistance. Device 300 may be designed as a metal oxide semiconductor field effect transistor (MOSFET) device which includes a substrate (or dielectric layer) 310 which is disposed in coplanar orientation with source electrode 320 and drain electrode 330. A floating gate 340 is disposed between a control gate 350 and source electrode 320 and drain electrode 330 on the substrate 310. The device 300 is a MOSFET device with floating gate 340. It is known that the conducting characteristics of a field effect transistor channel are dependent on the amount of charge on the gate structure or the island. The injection of a charge on such an island may be implemented by Fowler-Nordheim tunneling 360a or channel hot electron injection (CHE) 360b. Once the charge 360a or 360b is injected, the charge can remain in proper state for years without a concern of state change.

For a MOSFET device, the channel resistance depends on the structure and composition of the device as shown below in Equation (1):

$$R = {( \frac{Z}{L} \cdot μ \cdot {C}_{i} \cdot ( {V}_{G} - {V}_{T} ) )}^{- 1} \qquad ( 1 )$$

where
R=the channel resistance, in ohms (Ω);
Z=channel width in micrometers (μm);
L=channel length, in micrometers (μm);
Cᵢ=unit area dielectric layer capacitance, in farads/cm²;
μ=the mobility of the charge carrier, in cm²/volt-sec; and

V_{G}, and V_{T} are the effective gate voltage in volts and the threshold voltage in volts, respectively, in which V_{T} depends on the composition of the device and on the state of S1 and S2.

The deactivation or disabling process is reversible simply by injecting the charge 360a or 360b into the floating gate device 340 or draining the charge 360a or 360b from the floating gate device 340 via ground line 370, assuming the RFID portion 260 still functions. As a result, the foregoing MOSFET device 300 can serve the opening and closing functions of either switch S1 or S2.

The power controller 250 may control any floating gate device such as floating gate device 300. A kill device, such as an analog kill device, may be coupled across the terminals T1 and T2 and may control impedance and loss and read range and some RFID functionality. Data are input to demodulator 250d via junction 2 and data are output directly to switch S1, modulation impedance ΔZ, and switch S2 from modulator 250c. How well the switch S1 or S2 shorts determines the magnitude of the resistance ratio RR that is possible.

It is envisioned that embodiments of the present disclosure may be as dedicated hardware, such as a circuit, an application specific integrated circuit (ASIC), programmable logic device (PLD) or digital signal processor (DSP). In yet another embodiment the marker 100, semiconductor 130 or reader hardware may be designed using any combination of programmed general-purpose computer components and custom hardware components. The embodiments are not limited in this context.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A semiconductor for use with an electronic article surveillance (EAS) and radio frequency identification (RFID) marker, the semiconductor comprising:
a current receiving portion which couples to an antenna and is configured to communicate with at least one other portion of the semiconductor such that a multiplicity of functions can be performed by the at least one other portion of the semiconductor upon receiving and retransmitting energy and signals from the antenna; and
at least one of a first switch operatively coupled to the current receiving portion such that the multiplicity of functions are disabled upon closure of the first switch and a second switch operatively coupled to the current receiving portion such that at least one of the multiplicity of functions is at least partially disabled upon closure of the second switch.

2. The semiconductor according to claim 1, wherein at least one of the first switch and the second switch includes a preset memory.

3. The semiconductor according to claim 2, wherein the preset memory sets a conduction state of at least one of the first switch and the second switch.

4. The semiconductor according to claim 3, wherein the conduction state can be set during active operation of the semiconductor and can be maintained when the device is in a power down state by a power controller having memory storage for storing the conduction state.

5. The semiconductor according to claim 4, wherein the power controller modulates at least one of the first switch and the second switch.

6. The semiconductor according to claim 1, wherein the current receiving-portion is a front end portion comprising:
a source electrode;
a drain electrode;
a modulation impedance and a first diode both of which being operatively coupled to the source electrode and to the drain electrode to form a parallel resonant inductive capacitive (LC) circuit; and
a second diode operatively coupled to the drain electrode such that the LC circuit forms a current rectifying circuit.

7. The semiconductor according to claim 6, wherein the current receiving portion further comprises a capacitor which enables frequency matching of the resonance frequency of the front end portion to the frequency of an interrogation signal when received from the antenna.

8. The semiconductor according to claim 1, further comprising an antenna electromagnetically coupled to the semiconductor and designed to receive and retransmit the energy and signal from and to the current receiving portion.

9. An integrated electronic article surveillance (EAS) and radiofrequency identification (RFID) marker comprising:
an antenna;
a semiconductor adapted to couple to the antenna, and being configured to receive and transmit energy and signals to the antenna, the semiconductor including:
a current receiving end portion disposed in the semiconductor and configured to communicate with at least one other portion of the semiconductor such that a multiplicity of functions can be performed by the at least one other portion upon receiving and retransmitting the energy and signals from and to the antenna; and at least one of
a first switch operatively coupled to the current receiving portion such that the multiplicity of functions are disabled upon closure of the first switch; and
a second switch operatively coupled to the current receiving portion such that at least one of the multiplicity of functions is at least partially disabled upon closure of the second switch.

10. The integrated marker according to claim 9, wherein at least one of the first switch and the second switch includes a preset memory which sets a conduction state of at least one of the first and second switches.

11. The integrated marker according to claim 10, wherein the conduction state can be set during active operation of the semiconductor and can be maintained when the device is in a power down state by a power controller having memory storage for storing the conduction state.

12. The integrated marker according to claim 9, wherein the current receiving portion is a front end portion comprising:
a source electrode;
a drain electrode;
a modulation impedance and a first diode, both of which being operatively coupled to the source electrode and to the drain electrode to form a parallel resonant inductive capacitive (LC) circuit; and
a second diode operatively coupled to the drain electrode such that the LC circuit forms a current rectifying circuit.

13. The integrated marker according to claim 12, wherein the current receiving portion further comprises a capacitor which enables frequency matching of the resonance frequency of the front end portion to the frequency of an interrogation signal when received from the antenna.
